(19) United States
(12) Patent Application Publication
(10) Pub. No.: US 2022/0143940 A1
(43) Pub. Date: May 12, 2022

(54) Method For Making Glass Material Lens Array

(71) Applicants: CHOUNG LII CHAO, New Taipei City (TW); KUNG JENG MA, Taipei City (TW)

(72) Inventors: CHOUNG LII CHAO, New Taipei City (TW); KUNG JENG MA, Taipei City (TW)

(21) Appl. No.: 17/585,519

(22) Filed: Jan. 26, 2022

Related U.S. Application Data
(63) Continuation of application No. 16/689,055, filed on Nov. 19, 2019.

(51) Int. Cl. B29D 11/00

(52) U.S. Cl. CPC B29D 11/0048; B29D 11/00298

(57) ABSTRACT

A method for making glass material lens array, comprising: Step 1: providing a mold device, an upper mold, a lower mold a plate structure having plate body and through holes, and a plurality of lenses having lens body portions and annular portions; Step 2: placing the plurality of lenses on the lower mold cavities of the lower mold; Step 3: disposing the plate structure between the upper mold and the lower mold, to align the through holes with the lenses; Step 4: moving the plate structure downward, to have the lenses received within the through holes; Step 5: closing the upper mold and the lower mold, to make the upper mold pressing region abut and press the plate body; and Step 6: forcing and squeezing the plate body of the plate structure to deform, and generate a deformed region B flowing and covering a periphery of the annular portion.

### CROSS-REFERENCE TO RELATED APPLICATIONS

This application claims priority and is a continuation of U.S. patent application Ser. No. 16/689,055, filed Nov. 19, 2019 and titled “MOLD DEVICE FOR LENS ARRAY.”

### BACKGROUND OF THE INVENTION

### Field of the Invention

The present invention relates to a method for making lens array or a micro lens array, in particular, to a method for manufacturing glass-material lens array incorporated within a flat plate and a curved plate structure.

### Description of Related Art

With the booming development of optoelectronic industry, many precisions optical components have become smaller and lighter, and the shape of the component has also changed from flat, spherical, or regulate shapes into aspheric, non-axisymmetric or random shapes. That complex and freeform surfaces of the precision components will eventually bring the challenges to industrial accuracy, profile accuracy and surface roughness. For manufacturing these precisions optical components, the processing accuracy will reach as small as millimeter or micron scale. As a result, the surface shape accuracy of the optical components may approach sub-micron level, and the surface roughness may even reach the nanometer level. These precisions optical components are small in size and light in weight, therefore can fulfill special optical functions such as lens array or wave-front conversion, and thus go beyond the performance of traditional components. In this reason, the precisions optical components certainly have large amount of demand to the contemporary modern industry.

Taking the examples such as key components of imaging optical systems, illumination optics, optical communication, and Micro-Lens Array (MLA) used in optical signal processing systems, Light-Field camera for detecting the intensity, color and direction of light and capturing the light field information, or Wafer Level Optics, Wave-Front Detector, Optical Fiber Coupler, Brightness Enhancement Module of Liquid Crystal Display (LCD), pico projector and lens in CIS (contact image sensor), etc., which all use these high-precision optical components to output or couple optical parameters, enabling opto-mechanical instruments or devices to produce default optoelectronic functions.

More specifically, the Light-Field camera can record the intensity and color of light in different positions and the direction of light at different positions through the micro lens array, and then restores and processes the image through the imaging software, so as to adjust the optical focus variant to different depth of field and afterward produce new images. Or, the micro lens arrays are designed as a combination of micro lenses with multiple focuses, therefore 3D images and 3D depth information maps can be obtained only by one shoot of capturing images. Compared to traditional cameras that can only record the intensity of light at different locations, the micro lens array of the Light-Field camera obviously has wider utilization and better photoelectric value.

These optical innovation techniques described above all require the “complex eye” type of imaging vision and light collection system, which shall need the curved typed micro lens array to achieve the aforementioned functions. The curved typed micro lens array absolutely has wide usage potential in both commodities and military uses just because of its advantages of wide field of view, high detection sensitivity, small size, and light weight. Now, the curved typed micro lens array has been used in several scenarios such as robot vision systems, missile detection systems, and drone detection systems, etc.

Traditionally, the manufacture of planar micro lens arrays must consider the processing difficulty for the lens, the burden of molds, and process conditions. In general, the processing conditions for curved micro lens arrays will be more stringent and more complex, so Germany, Japan, the United States, Canada, Britain and other countries are betting on many R&D resources for technical development and seeking breakthroughs.

Therefore, the goal of those who have the usual knowledge in the art is to manufacture both flat type and curved type lens arrays/micro lens arrays through different sizes or different materials of lens in a more convenient and economical way, so as to overcome the current technical bottleneck.

### SUMMARY OF THE INVENTION

The main purpose of the present invention is to manufacture a curved type/flat typed glass material lens array or a micro lens array.

Another purpose of the present invention is to produce a curved type/flat typed glass material lens array or a micro lens array through a precise, structural feasible, and economical way.

In order to solve above and other problems, the present invention provides a method for making glass material lens array, comprising: Step 1: providing a mold device, an upper mold, a lower mold a plate structure having plate body and through holes, and a plurality of lenses having lens body portions and annular portions; Step 2: placing the plurality of lenses on the lower mold cavities of the lower mold; Step 3: disposing the plate structure between the upper mold and the lower mold, to align the through holes with the lenses; Step 4: moving the plate structure downward, to have the lenses received within the through holes; Step 5: closing the upper mold and the lower mold, to make the upper mold pressing region abut and press the plate body; and Step 6: forcing and squeezing the plate body of the plate structure to deform, and generate a deformed region B flowing and covering a periphery of the annular portion.

According to an embodiment of the method for making glass material lens array described above, the characteristic is that the annular portion of the lens is spaced apart from a side wall of the through hole by a spacing S2.

According to an embodiment of the method for making glass material lens array described above, the characteristic is that the lower mold cavity sustains and contacts the lens body portion or the annular portion.

According to an embodiment of the method for making glass material lens array described above, the characteristic is that a lower end of at least one of the lower mold cavities is connected to a suction passage.

According to an embodiment of the method for making glass material lens array described above, the characteristic is that the upper mold cavity or the lower mold cavity has a quadrangular cross section.

According to an embodiment of the method for making glass material lens array described above, the characteristic is that the lens body portion of the lens is a convex structure, a concave structure or a structure of Fresnel lens.

According to an embodiment of the method for making glass material lens array described above, the characteristic is that shapes of the lens body portions of the plurality of lenses are different from each other, or glass transition temperatures of the lenses are different from each other.

According to an embodiment of the method for making glass material lens array described above, the characteristic is that the plurality of through holes of the plate structure are arranged in sequence, alternately arranged or regularly arranged.

According to an embodiment of the method for making glass material lens array described above, the characteristic is that the glass transition temperature of the plate structure is lower than the glass transition temperature of the lens, or a softening point temperature of the plate structure is lower than a softening point temperature of the lens.

According to an embodiment of the method for making glass material lens array described above, the characteristic is that at least one outer edge of the upper mold cavity is spaced away from the lens by a spacing S3 in a transversal direction when the upper mold pressing region moves to contact the plate body, and wherein the spacing S3 is greater than zero.

According to an embodiment of the method for making glass material lens array described above, the characteristic is that the lens has at least one notch or pattern disposed on the annular portion along axial or angular direction.

According to an embodiment of the method for making glass material lens array described above, the characteristic is that the lens body portion is non-symmetrical with respect to the annular portion, and the lens body portion can be cone-shaped or pyramid-shaped.

According to an embodiment of the method for making glass material lens array described above, the characteristic is that a thickness of the plate body is greater than a thickness of the annular portion.

According to an embodiment of the method for making glass material lens array described above, the characteristic is that when the upper mold and the lower mold are moved to close in a first direction, the lens body portion has a spacing away from a lower edge of the upper mold along the first direction. In a further embodiment, the spacing is greater than a plastic deformation d squeezed through the upper mold pressing region pressing the plate body.

Therefore, the mold device and the method for making glass material lens array of the present invention takes advantages of mass-produced and high-precision lenses (pre-manufactured in advance) through disposed and combined with a flat or curved plate structure. Due to the lower glass transition temperature (low Tg value) of the plate structure, the mold device can be kept in relative lower mold pressure, therefore it can overcome the technical bottleneck of mold pressure and difficulty in manufacturing. In this manner, manufacturing a lens array or a micro lens array with shape of flat plate or curved plate, by using different sizes or different materials of lenses, through more convenient and economical means is absolutely possible. Therefore, the present invention has great potential in commercial use.

### BRIEF DESCRIPTION OF THE DRAWINGS

FIG. 1A is a diagram of a lens.

FIGS. 1B to 1E are diagrams showing a mold combining process of the mold device for lens array according to an embodiment of the present invention.

FIGS. 1F to 1G are structural diagrams of the lens array after molding according to an embodiment of the present invention.

FIG. 2 is a diagram of a lens of a different configuration used in the mold device for lens array according to an embodiment of the present invention.

FIGS. 3 to 7 are diagrams showing mold devices of the lens array of according to other embodiments of the present invention.

FIGS. 8A to 8B are diagrams showing the in-mold state of the mold device according to an embodiment of the present invention.

FIGS. 9A to 9D are diagrams showing several embodiments of pre-manufactured lens.

FIGS. 10A to 10B are diagrams showing other structure of lens and mold device.

### DETAILED DESCRIPTION OF THE EMBODIMENTS

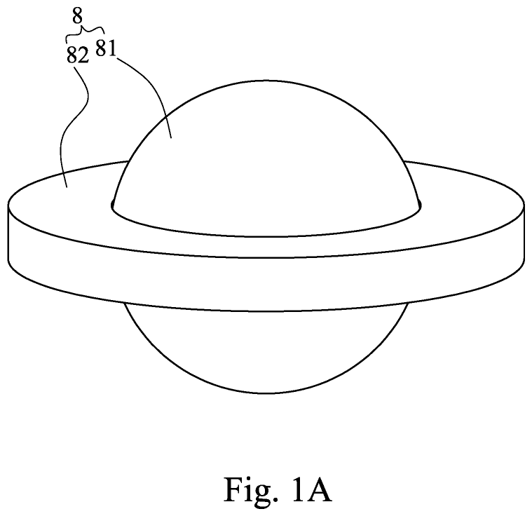

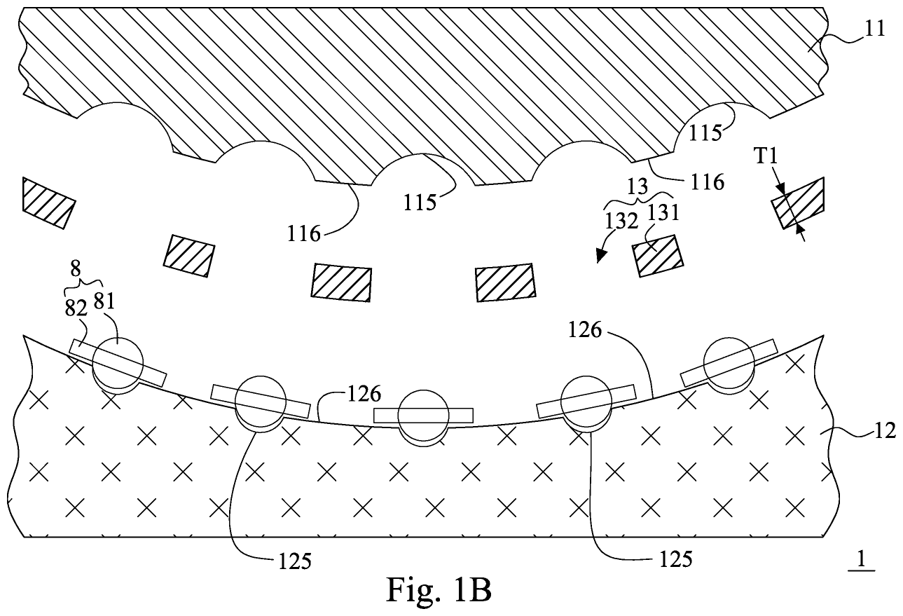

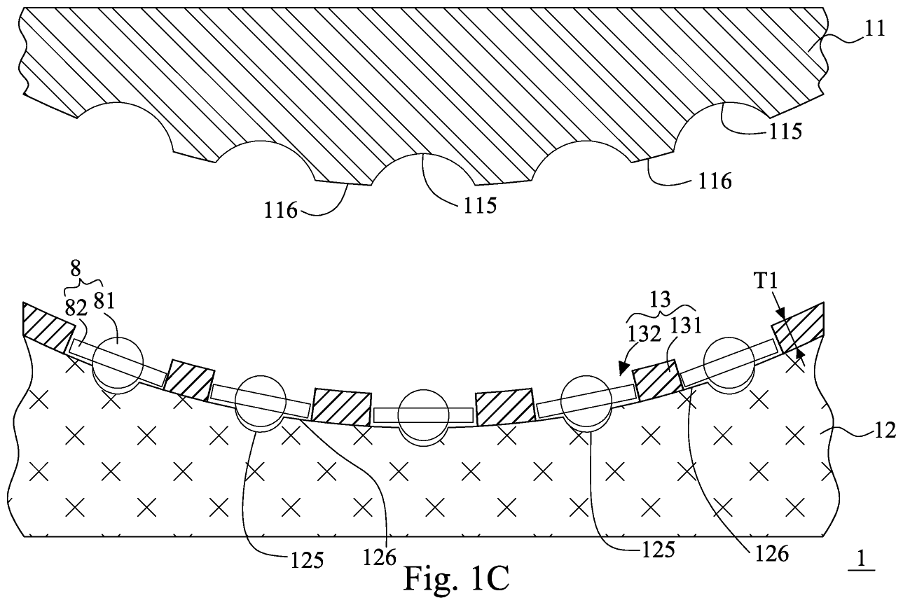

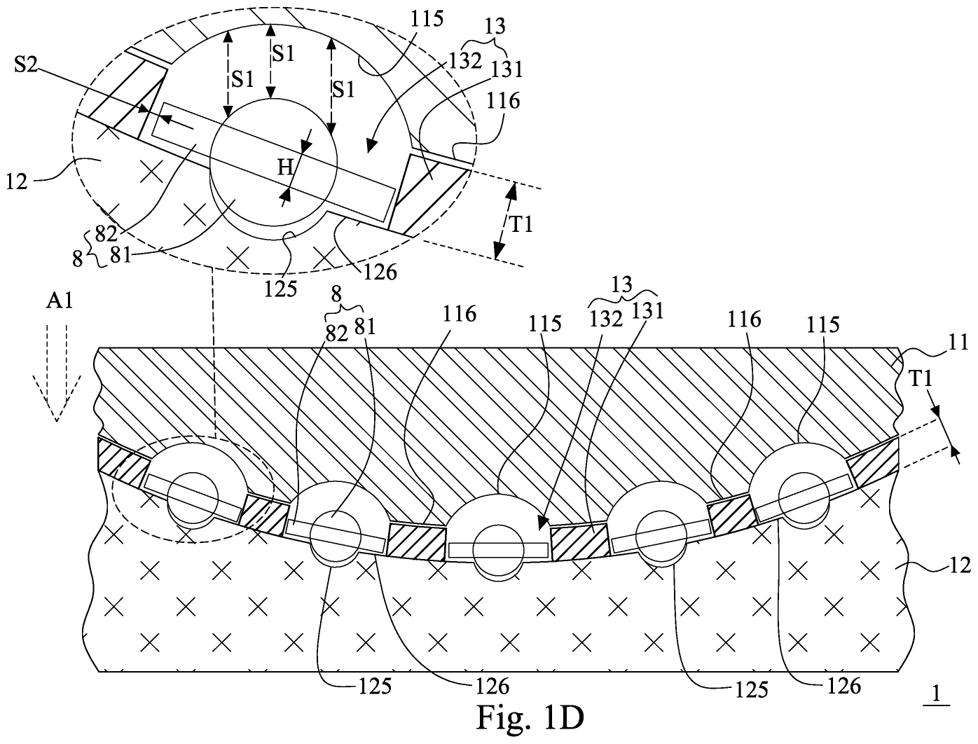

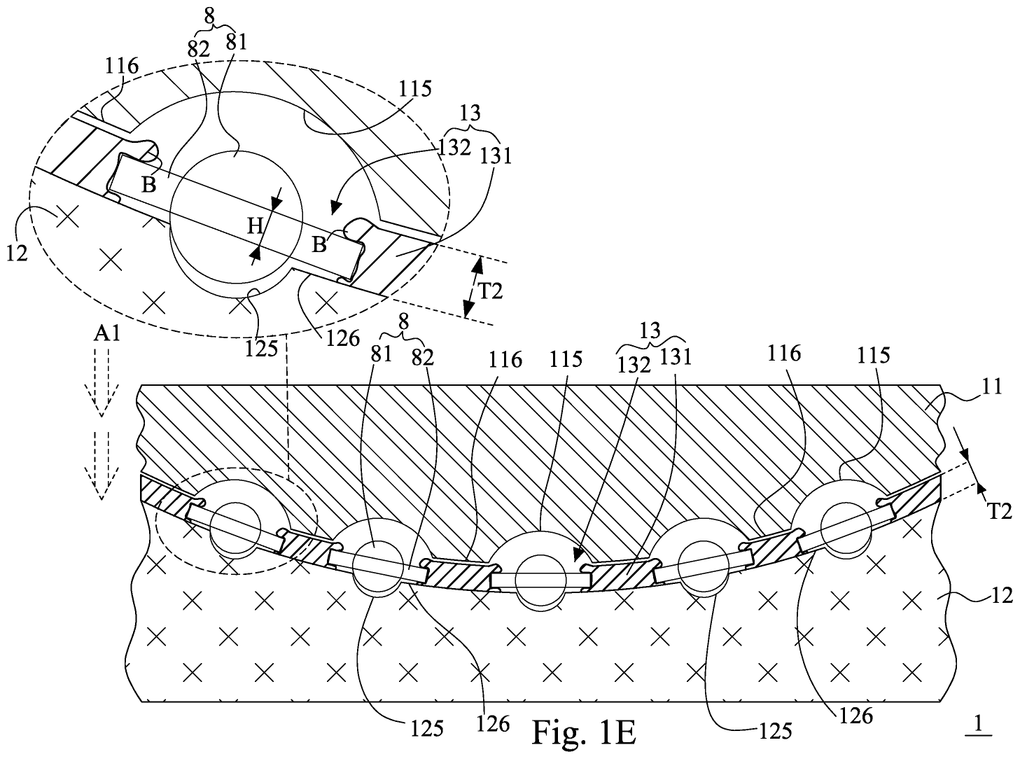

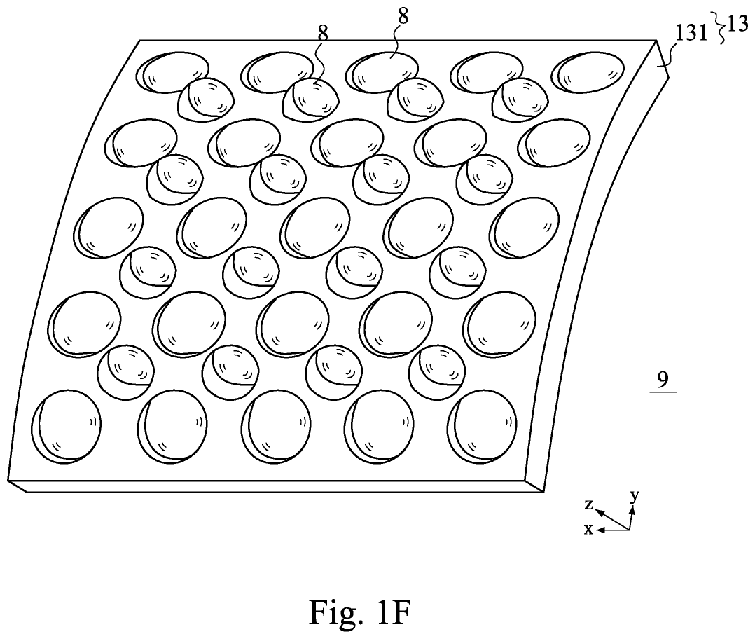

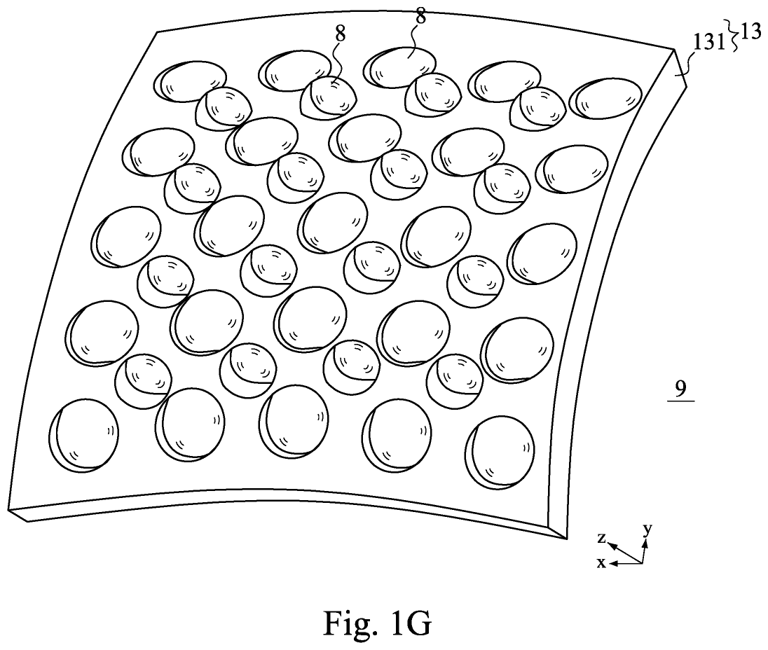

With reference to FIG. 1A, FIG. 1A is a diagram of a lens. As shown, a lens 8 includes a lens body portion 81 and an annular portion 82, wherein the annular portion 82 surrounds the lens body portion 81. The lens body portion 81 of the present embodiment has a convex structure. In other embodiments, the lens body portion 81 of the lens 8 may also be a double concave structure, a convex-flat structure, a concave-flat structure, a convex-concave structure, or a Fresnel lens structure. The lens 8 can be manufactured in large quantities beforehand; because the profile of the lens body 81 is a simple geometric such as surface or plane, the pre-fabrication for lenses 8 can have both advantages of batch fabrication and precision. With reference to FIGS. 1B to 1E, FIGS. 1B to 1E are diagrams showing a mold combining process of the mold device for lens array according to an embodiment of the present invention. As shown in FIG. 1B, the mold device 1 for lens array of the present invention aims at pressing a plurality of lenses 8 onto a curved plate structure 13. The material of the plate structure 13 can be, but not limited to, metal, alloy, ceramic, glass, polymer composite material and the like. The plate structure 13 includes a plate body 131 with a thickness T1, and a plurality of through holes 132 disposed on the plate body 131. The mold device 1 may include an upper mold 11 and a lower mold 12. The upper mold 11 includes a plurality of upper mold pressing regions 116 and a plurality of upper mold cavities 115 disposed at lower edge of the upper mold 11. The lower mold 12 includes a plurality of lower mold pressing regions 126 and a plurality of lower mold cavities 125 disposed at upper edge of the lower mold 12. The plate structure 13 is movably disposed between the upper mold 11 and the lower mold 12. The plurality of lenses 8 are first placed on the plurality of lower mold cavities 125 of the lower mold 12 such that each of the lenses 8 corresponds to a lower mold cavity 125. Then, as shown in FIG. 1C, the plate structure 13 is moved downward so that the plurality of through holes 132 of the plate structure 13 can correspond to the plurality of lenses 8. In this way, the plurality of lenses 8 are respectively disposed in the plurality of through holes 132 of the plate structure 13 such that each of the lenses 8 is received in a through hole 132. And then, as shown in FIG. 1D, the upper mold 11 is moved downward, and the upper mold 11 and the lower mold 12 move along a first direction A1. When the upper mold 11 contacts the plate structure 13, the upper mold pressing region 116 abuts against the plate body 131. Meanwhile, each of the upper mold cavities 115 may correspond to a lens 8 and a lower mold cavity 125 along the first direction A1. The lens body portion 81 has a spacing S1 away from the upper mold cavity 115 in the first direction A1. As shown in the enlarged view of FIG. 1D, the spacing S1 at different positions has different lengths, which means that the spacing S1 is variant of position. As shown in FIG. 1E and its enlarged view, the upper mold 11 continues to move downward along the first direction A1. When the upper mold pressing region 116 and the lower mold pressing region 126 abut against the plate body 131 of the plate structure 13 along the first direction A1, the plate body 131 of the plate structure 13 is squeezed and then plastically deformed, so as to form a deformed region B. Due to the squeeze and pressing force, the deformed region B of the plate body 131 flows and covers the periphery of the annular portion 82 of the lens 8, so that the plate structure 13 may bond and fix the plurality of lenses 8. That is to say, the annular portion 82 of the lens 8 is covered by the deformed region B, so that the plurality of lenses 8 are fixed and attached on the plate structure 13, without loosening or falling off. As shown in FIGS. 1F and 1G, the plurality of lenses 8 are fixed on the plate structure 13, so that a lens array 9 is formed. The lens array 9 demonstrated in FIG. 1F is curved along the y-axis (i.e., one-dimensional curved plate), and the lens array 9 demonstrated in FIG. 1G is curved along both x-axis and y-axis (i.e., two-dimensional curved plate). In this embodiment, the contour of the lower mold cavity 125 is similar to the contour of lower part of the lens 8, so the lens 8 may be stably attached or laid flat on the lower mold cavity 125. In addition, the shapes and configurations of the plurality of lenses 8 shown in the embodiments of FIGS. 1F and 1G may also be diversified. In other embodiments, the shapes of the lens body portions 81 within the lens array 9 may be different from each other, or the glass transition temperatures of the lens body portions 81 are also diversified. Furthermore, in other different embodiments, the plurality of through holes 132 of the plate structure 13 may be arranged in sequence, alternately arranged or regularly arranged. Of course, the plate body 131 of the plate structure 13 may also be non-transparent (e.g., subjected to surface coating, surface coating, surface blasting, surface atomization, surface attachment, or internal doping of the plate structure 13).

Further, the glass transition temperature (Tg) of the plate structure 13 is lower than the glass transition temperature of the lens 8, or the temperature of softening point of the plate structure 13 is also lower than the temperature of softening point of the lens 8. Therefore, when the plate structure 13 and the lens 8 are simultaneously subjected to the abutting and pressing force within the mode device 1, the plate body 131 of the plate structure 13 may be first plastically deformed to produce the deformed region B. And, the plate body 131 has a thickness T1 before pressed (as shown in an enlarged view of FIG. 1D); afterward the plate body 131 deforms and becomes to have a thickness T2 (as shown in an enlarged view of FIG. 1E) if the upper mold pressing region 116 is moved downward along the first direction A1 to abut against and squeeze the plate body 131. The difference between the thickness T1 and the thickness T2 is the plastic deformation d of the plate structure 13 along the first direction A1; that is, T1−T2=d. As shown in the enlarged view of FIG. 1D and the enlarged view of FIG. 1E, the annular portion 82 has a thickness H, and the original thickness T1 of the plate body 131 is greater than the thickness H of the annular portion 82. When the upper mold 11 squeezes and presses the plate body 131 of the plate structure 13, the plate body 131 decreases the thickness T1, due to plastic deformation, and the reduction (i.e., the plastic deformation d) is smaller than the spacing S1, that is, the spacing S1 is larger than the plastic deformation d of the plate body 131 (that is, S1 is larger than d). In this way, it can be ensured that the contour of the upper mold cavity 115 may not scratch, damage or press the lenses 8.

In the embodiments of FIGS. 1B to 1D, the plurality of lenses 8 are first placed in the plurality of lower mold cavities 125 of the lower mold 12, followed by aligning the plurality of through holes 132 with the plurality of lenses 8, and afterward the plate structure 13 is moved downward for the closing the mold (i.e., the upper mold 11 is moved downward). In other embodiments, alternatively, the plurality of through holes 132 of the plate structure 13 can be aligned with the plurality of lower mold cavities 125, followed by attaching the plate structure 13 onto the lower mold 12, and finally, a plurality of lenses 8 are placed into the plurality of through holes 132, so that the lower portion of the lens 8 is attached to the contour of the lower mold cavity 125. In addition, as shown in the enlarged view of FIG. 1D, the annular portion 82 of the lens 8 is spaced apart from the side wall of the through hole 132 by an appropriate spacing S2. In this way, it is possible to avoid the occurrence of misalignment or structural jamming if the lens 8 is placed in the through hole 132 of the plate structure 13. Moreover, the contour of the lower mold cavity 125 coincides with the contour of the lower end of the lens body portion 81 or the annular portion 82, so that the lower mold cavity 125 can support the lens body portion 81 or the annular portion 82 more accurately.

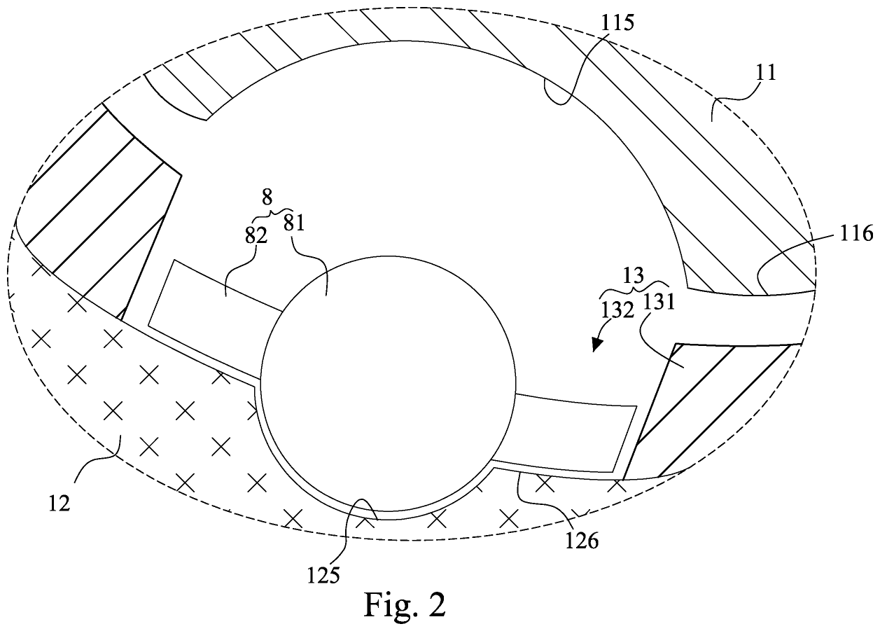

With reference to FIG. 2, FIG. 2 is a diagram of a lens of a different configuration used in the mold device for lens array according to an embodiment of the present invention. In this embodiment, the sectional view of the annular portion 82 of the lens 8 is slightly curved, so that the contours the lower end portions of the lens body portion 81 and the annular portion 82 may be completely matched with the lower mold 12 and the lower mold cavity 125. When the upper mold 11 and the lower mold 12 are approached to each other, the extreme in-mold pressure may not scratch or destroy the lenses 8.

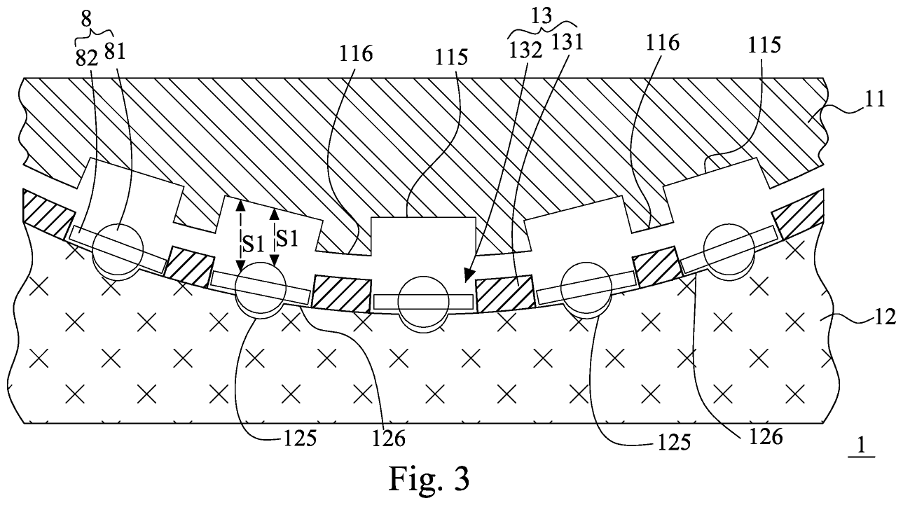

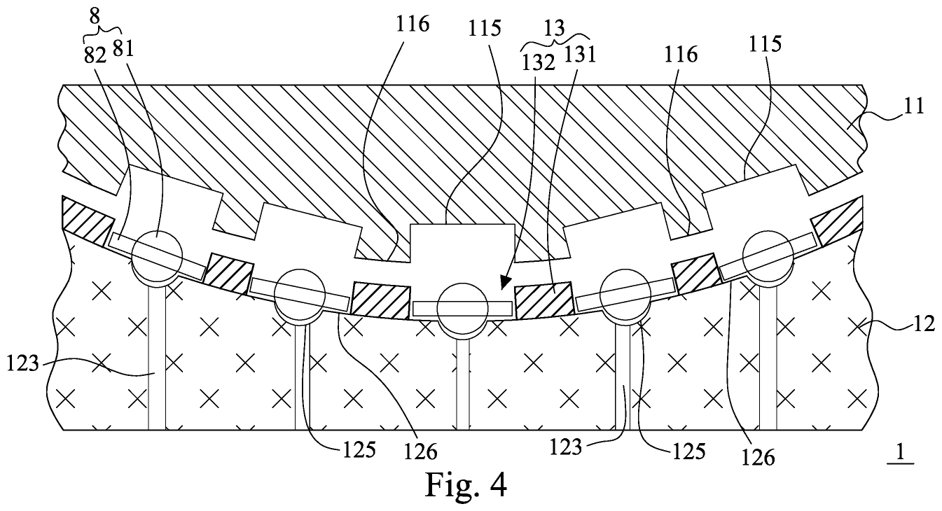

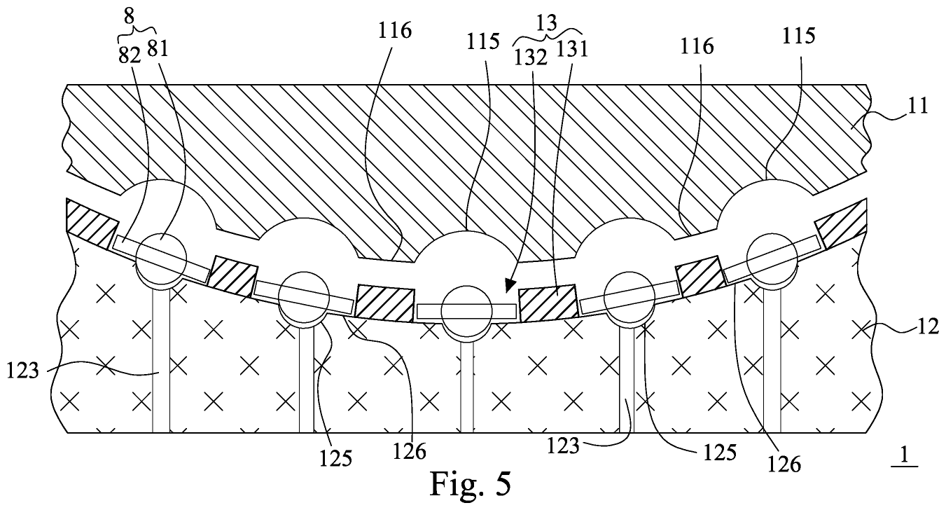

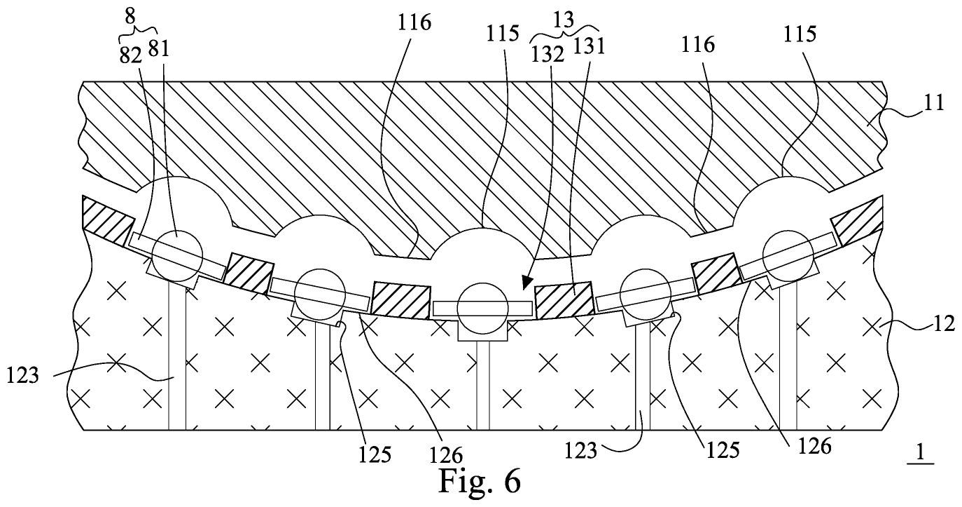

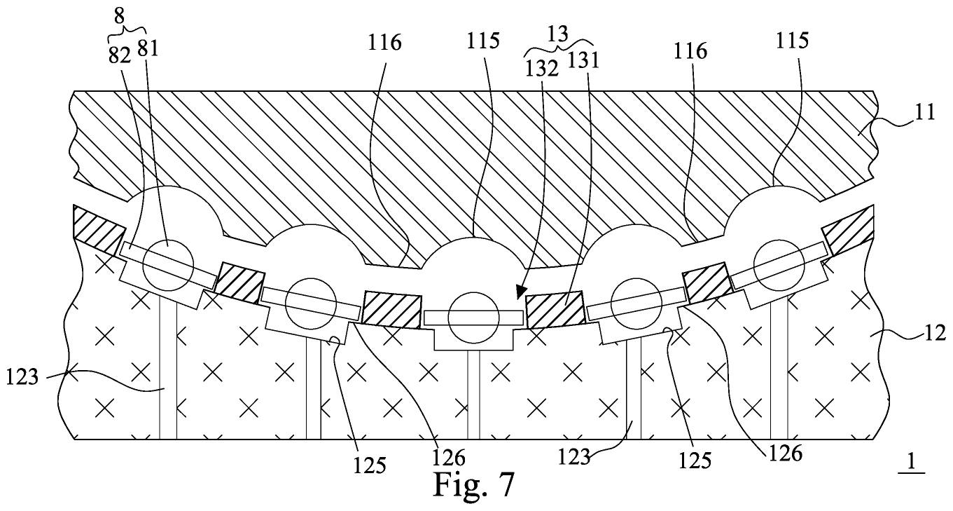

FIGS. 3 to 7 are diagrams showing mold devices of the lens array according to other embodiments of the present invention. As shown in FIG. 3, the upper mold cavity 115 of the upper mold 11 has a rectangular or a quadrangular cross-sectional shape. When the upper mold 11 and the lower mold 12 are closed and approached to each other, the spacing S1 between the upper end portion of the lens 8 and the upper mold cavity 115 is larger enough, so as to ensure that the upper mold cavity 115 will not scratch or touch the contour of the lenses 8. It should be noted that the mold device 1 of this embodiment is particularly suitable for the manufacture of solar lens, to ensure the function of focusing the incident light. In addition to the application of solar lens, the present invention may also be used in many other technical fields such as imaging optical systems, illumination optical systems, optical communication or optical signal processing systems. As shown in FIG. 4, a suction passage 123 is disposed and connected to the lower mold cavities 125. When the suction passage 123 performs pumping, the lens 8 can be sucked through the pressure of the vacuum, so that the lens 8 can be firmly attached onto the lower mold cavity 125. By the way, the lens 8 can also be guided movement so as to enter the through hole 132 of the plate structure 13. Among which, the lower mold 12 is provided with the suction passage 123, which may be partitioned (partially disposed, and some other parts not disposed), or disposed according to different sizes of the lenses 8, or may be disposed according to different contour and size requirements for the lenses 8. Here, providing the suction passage 123 is to improve manufacturing automation, so that the plurality of lenses 8 may be automatically and quickly located into the through hole 132 or the periphery of the lower cavity 125; besides, it may also prevent the lenses 8 from loosening, dropping off or separating from the lower mold cavity 125 when disposed within the mold device 1 to suffer the extreme pressure. As shown in FIG. 5, the lower mold 12 of this embodiment has the suction passages 123 disposed, and the upper mold cavity 115 of the upper mold 11 has arc shaped. As shown in FIG. 6, the lower mold cavity 125 of this embodiment has a rectangular or a quadrangular cross-section, so that the lens 8 may has the lens body portion 81 mounted onto the lower mold cavity 125 through annular portion 82. The lens body portion 81 of this embodiment is slight contacted with the side wall of the lower mold cavity 125. As shown in FIG. 7, the rectangular or quadrangular shape of the lower mold cavity 125 is larger, so the lens body portion 81 is suspended on the lower mold cavity 125 through the annular portion 82.

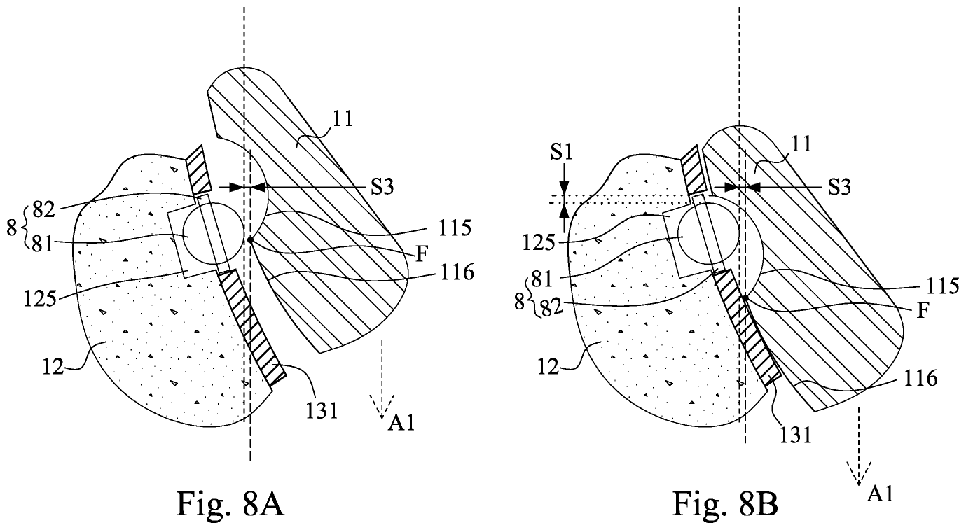

With reference to FIGS. 8A to 8B, FIGS. 8A to 8B are diagrams showing the in-mold state of the mold device according to an embodiment of the present invention. As shown in FIGS. 8A and 8B, if the lens array 9 has a larger curvature, the upper mold 11 may scratch or damage the lens body portion 81 or the annular portion 82 of the lens 8 (occurred around the edge of the lens array 9) when the upper mold 11 and the lower mold 12 of the mold device 1 are approached to each other along the first direction A1. Therefore, when the upper mold pressing region 116 moves downward to contact the plate body 131, the rightmost side portion F of the upper mold cavity 115 is spaced apart from the lens 8 by a spacing S3 in a transversal direction (i.e., a horizontal direction), and the spacing S3 is greater than zero, so as to prevent the upper mold 11 from scratching and crushing the lens 8 upon moving in the first direction A1 for mold closing. That is to say, when the upper mold pressing region 116 moves downward to contact the plate body 131, the lens body portion 81 has a spacing S1 away from the upper mold cavity 115 in the first direction A1, and concurrently the rightmost side portion F of the upper mold cavity 115 is also spaced apart from the lens 8 by a spacing S3 in the horizontal direction. The spacings S1 and S3 is to ensure that the upper mold 11 may not scratch and damage the lens 8 upon moving for mold closing.

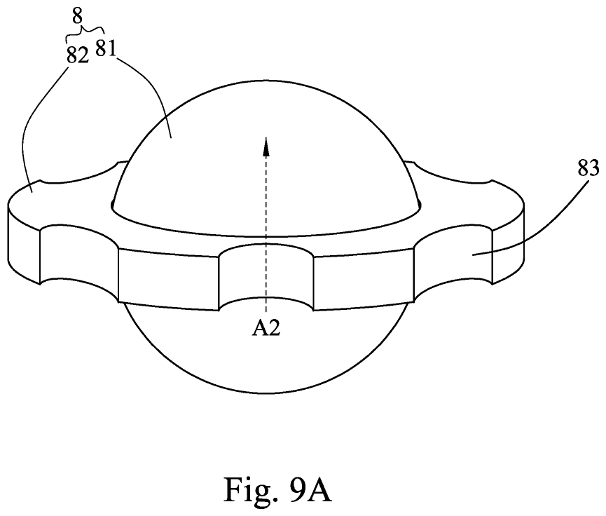

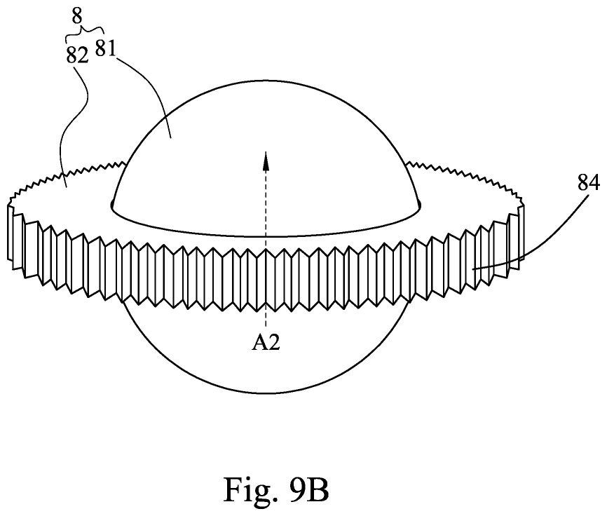

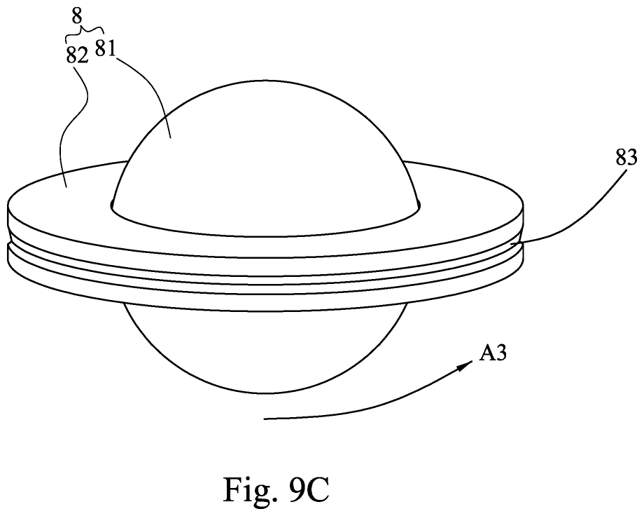

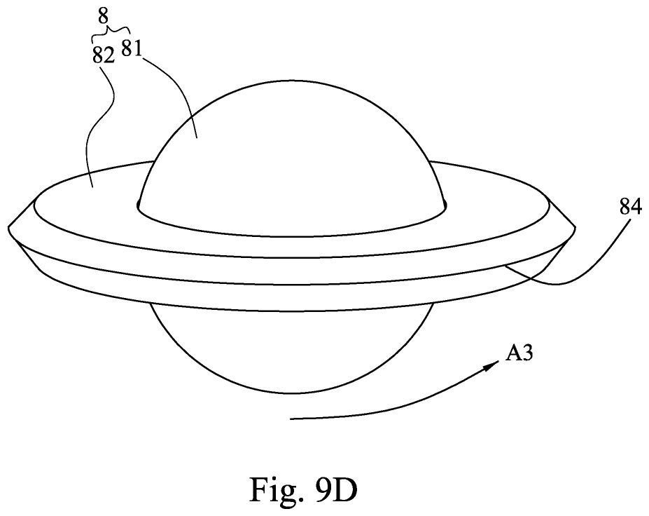

Besides, the lens 8 might sometimes loose or depart from the plate structure 13 if the lens 8 suffers external force or the plate structure 13 has thermal expansion and contraction. The lens 8 can have further design to prevent from this. Further demonstrated in FIGS. 9A to 9D, which are diagrams showing several embodiments of pre-manufactured lens 8. As shown in FIG. 9A, the lens 8 has several notches 83 disposed at outer edge of the annular portion 82, in which the notches 83 go along the axial direction A2. In this manner, outer edge of annular portion 82 can be firmly engaged to or attached with plate structure 13 through the disposure of the notches 83; thus falling down or loosing from the plate structure 13 will not happen anymore.

As shown in FIG. 9B, the lens 8 has several patterns 84 disposed at outer edge of the annular portion 82, in which the patterns 84 go along the axial direction A2. As shown in FIG. 9C, the lens 8 has at least one notch 83 disposed at outer edge of the annular portion 82, in which the notch 83 goes along the angular direction A3. Further shown in FIG. 9D, the lens 8 has at the pattern 84 disposed at outer edge of the annular portion 82, in which the pattern 84 protrudes from the annular portion 82 and goes along the angular direction A3.

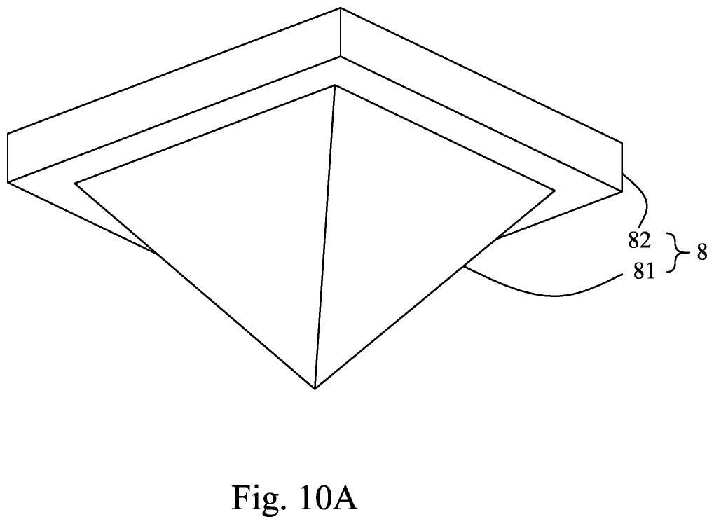

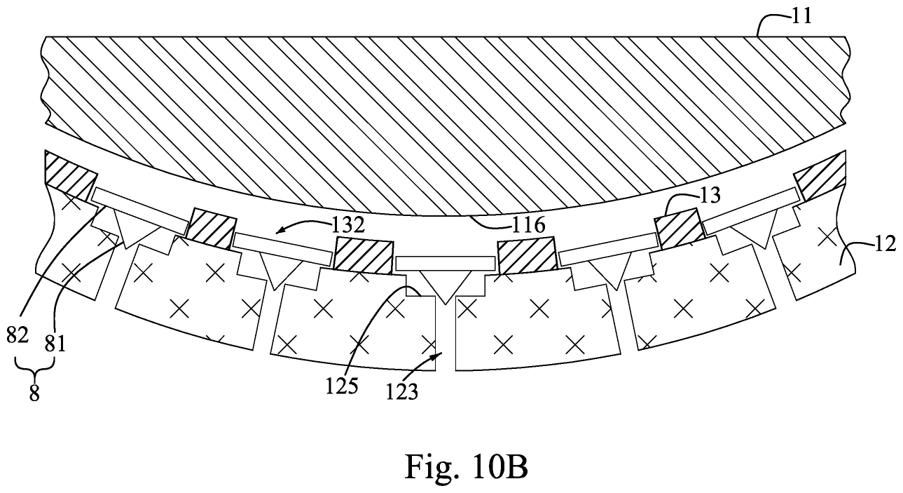

Further embodiment as shown in FIG. 10A and FIG. 10B, the lens body portion 81 is a pyramid disposed beneath the annular portion 82. The body portion 81 can has various shapes such as cone-shaped. As shown in FIG. 10A, the lens body portion 81 is non-symmetrical with respect to the annular portion 82, such that the upper end of the annular portion 82 is flat and the lower end of the annular portion 82 is connected with pyramid-shaped body portion 81. When the pyramid-shaped lenses 8 are disposed within the mold device 1, as shown in FIG. 10B, the plate structure 13 can be pressed and squeezed by the upper mold 11. Afterward the plate structure 13 is deformed to attach and fasten the plurality of lenses 8. In this embodiment, lower end of the upper mold 11 is smooth; namely the upper mold pressing regions 116 are disposed at lower edge of the upper mold 11 to form a smooth and continuous shape. Furthermore, the suction passages 123 can facilitate to hold and maintain the lenses 8 from falling away by means of the vacuum suction force. Therefore, the mold device 1 of lens array 9 of the present invention takes advantages of mass-produced and high-precision lenses 8 (pre-manufactured in advance) through disposed and combined with a flat or curved plate structure 13. Due to the lower glass transition temperature (low Tg value) of the plate structure 13, the mold device 1 can be kept in relative lower mold pressure, therefore it can overcome the technical bottleneck of mold pressure and difficulty in manufacturing. In this manner, manufacturing a lens array 9 or a micro lens array with shape of flat plate or curved plate, by using different sizes or different materials of lenses 8, through more convenient and economical means is absolutely possible. Therefore, the present invention has great potential in commercial use.

What is claimed is:

1. A method for making glass material lens array, comprising:
providing a mold device (1), a plate structure (13) and a plurality of lenses (8), the plate structure (13) having a plate body (131) and a plurality of through holes (132) disposed thereon, the lens (8) having a lens body portion (81) and an annular portion (82) surrounding the lens body portion (81), the mold device (1) having an upper mold (11) and a lower mold (12), the upper mold (11) having a plurality of upper mold pressing regions (116) and a plurality of upper mold cavities (115) disposed thereon, the lower mold (12) having a plurality of lower mold pressing regions (126) and a plurality of lower mold cavities (125) disposed thereon, with the upper mold cavities (115) neighboring the upper mold pressing regions (116), and the lower mold cavities (125) neighboring the lower mold pressing regions (126);
placing the plurality of lenses (8) on the lower mold cavities (125) of the lower mold (12);
disposing the plate structure (13) between the upper mold (11) and the lower mold (12), to align the through holes (132) with the lenses (8);
moving the plate structure (13) downward, to have the lenses (8) received within the through holes (132);
closing the upper mold (11) and the lower mold (12), to make the upper mold pressing region (116) abut and press the plate body (131); and
forcing and squeezing the plate body (131) of the plate structure (13) to deform, and generate a deformed region (B) flowing and covering a periphery of the annular portion (82).

2. The method for making glass material lens array according to claim 1, wherein the annular portion (82) of the lens (8) is spaced apart from a side wall of the through hole (132) by a spacing S2.

3. The method for making glass material lens array according to claim 1, wherein the lower mold cavity (125) sustains and contacts the lens body portion (81) or the annular portion (82).

4. The method for making glass material lens array according to claim 1, wherein a lower end of at least one of the lower mold cavities (125) is connected to a suction passage (123).

5. The method for making glass material lens array according to claim 1, wherein the lower mold cavity (125) has a quadrangular cross section.

6. The method for making glass material lens array according to claim 1, wherein the lens body portion (81) of the lens (8) is a convex structure, a concave structure or a structure of Fresnel lens.

7. The method for making glass material lens array according to claim 1, wherein the shapes of the lens body portions (81) of the plurality of lenses (8) are different from each other, or glass transition temperatures of the lenses (8) are different from each other.

8. The method for making glass material lens array according to claim 1, wherein the plurality of through holes (132) of the plate structure (13) are arranged in sequence, alternately arranged or regularly arranged.

9. The method for making glass material lens array according to claim 1, wherein the glass transition temperature of the plate structure (13) is lower than the glass transition temperature of the lens (8), or a softening point temperature of the plate structure (13) is lower than a softening point temperature of the lens (8).

10. The method for making glass material lens array according to claim 1, wherein the upper mold cavities (115) are corresponded to the plurality of lower mold cavities (125), and at least one outer edge of the upper mold cavity (115) is spaced away from the lens (8) by a spacing S3 in a transversal direction when the upper mold pressing region (116) moves to contact the plate body (131), and wherein the spacing S3 is greater than zero.

11. The method for making glass material lens array according to claim 1, wherein the lens (8) has at least one notch (83) or pattern (84) disposed on the annular portion (82) along axial or angular direction.

12. The method for making glass material lens array according to claim 1, wherein the lens body portion (81) is non-symmetrical with respect to the annular portion (82).

13. The method for making glass material lens array according to claim 12, wherein lens body portion (81) is cone-shaped or pyramid-shaped.

14. The method for making glass material lens array according to claim 1, wherein a thickness (T1) of the plate body (131) is greater than a thickness (H) of the annular portion (82).

15. The method for making glass material lens array according to claim 1, wherein, when the upper mold (11) and the lower mold (12) are moved to close in a first direction (A1), the lens body portion (81) has a spacing (S1) away from a lower edge of the upper mold (11) along the first direction (A1).

16. The method for making glass material lens array according to claim 15, wherein the spacing (S1) is greater than a plastic deformation d squeezed through the upper mold pressing region (116) pressing the plate body (131).
